(19) United States
(12) Patent Application Publication
(10) Pub. No.: US 2015/0173338 A1
(43) Pub. Date: Jun. 25, 2015

(54) Apparatus and Method for Trapping Flying Insects

(71) Applicants: Patrick McCammon, Leo, IN (US); Andrew Rekeweg, Woodburn, IN (US)

(72) Inventors: Patrick McCammon, Leo, IN (US); Andrew Rekeweg, Woodburn, IN (US)

(21) Appl. No.: 14/137,171

(22) Filed: Dec. 20, 2013

(51) Int. Cl. A01M 1/08; A01M 1/02; A01M 1/06

(52) U.S. Cl. CPC A01M 1/08; A01M 1/06; A01M 1/023

(57) ABSTRACT

A trap for collecting flying insects, said trap comprising: a housing; a means within the housing for forcing air movement, a means for containing an attractant; and a means for collecting insects, said means for collecting insects further comprising means for preventing insects from exiting said means for collecting insects.

### BACKGROUND

1. Field of the Art

The present invention relates generally to devices and methods for collecting flying insects for study. More specifically, but without limitation, the present invention relates to a device and method for collecting undamaged samples of mosquitoes for study using a human attractant where the device comprises a commercially viable suction trap that uses a human attractant in a non-hazardous manner for the surveillance and control of mosquito, midge, sand fly, and other disease vectors.

Biting insects, mosquitoes, midges, and sand flies pose a danger to deployed military personnel and humans in locations around the globe because of the possible transmission of blood-borne diseases such as malaria, dengue fever, and leishmaniasis. Malaria alone is one of the most common blood-borne diseases on earth, infecting nearly a half-billion people.

Epidemic dengue fever has increased dramatically since 1980, and in 2005, dengue was the most important mosquito-borne viral disease affecting humans. Its global distribution is comparable to that of malaria, according to the Centers for Disease Control and Prevention's (“CDC”) Dengue Fever fact sheet.

Leishmaniasis is a parasitic disease spread by the bite of infected sand flies. The number of new cases of cutaneous leishmaniasis each year in the world is thought to be about 1.5 million, while the number of new cases of visceral leishmaniasis is thought to be about 500,000, according to the Centers for Disease Control Leishmania Infection fact sheet.

It is because of these disease dangers that the collection of specimens during entomological surveys is incredibly important.

2. Description of the Prior Art

Studies show that human odor, created from expelled carbon dioxide, heat, and/or perspiration, is the best way to attract mosquitoes and other biting insects. In fact, some sampling methods use a human landing catch system. However, such systems are cumbersome and labor intensive. Additionally, and more critically, current human baited methods of collection pose potential hazards for the humans collecting the specimens because the humans become directly exposed to the very specimens being collected for disease-carrying analysis.

Another collection method relies on the tendency of the specimens to rest indoors after blood feeding. Collection occurs at accessible resting places or by knocking the resting specimens down with spray and gathering them onto white sheets. However, the resulting presence of insecticides is typically unsuitable.

Collections that rely on exit traps in windows can be useful, but the efficiency can be influenced by site and time-specific factors and building design. Because of these challenges, too often the resulting samples collected are unreliable for representative, consistent and meaningful insect-biting studies.

Some tent traps have been created as an alternative to the human landing catch system. For example, passive tent collection systems are in use, but they have not proven very efficient at specimen collection. Exemplary tent traps include the Furvella tent trap, Ifakara tent trap, and the CDC miniature light trap.

The Furvella tent trap uses a sleeping tent and light, relying on a suction created by a rotating fan near the tent entrance to attract and capture the specimens. The Ifakara tent trap is created from canvas boxes with funnel-like entrances and inner small apertures which allow the specimens to enter the trap. A commonly used CDC trap uses a light and a fan to attract and capture specimens within a holding reception. Another CDC trap uses a canister of dry-ice to produce carbon dioxide and a battery operated fan to suction mosquitoes into a holding receptacle.

Other insect traps in the prior art include those disclosed in the following issued U.S. patents and published U.S. patent applications:

U.S. Pat. No. 3,796,001 discloses a weatherproof trap which will capture mosquitoes or other insects using a fan and light mounted on a support plate within the trap, and catch trap means mounted between the open end of the trap and the support plate. The trap is closed at its opposite end by a cover, the opposite end having air escape means therein.

U.S. Pat. No. 4,282,673 discloses a device for trapping live flying insects, such as mosquitoes including an electric light reflected by a parabolic reflector horizontally in all directions to attract the mosquitoes, and electric fan to blow the mosquitoes downwardly into a collection bag, and a valve between the fan and the collection bag which is biased to close the entrance to the collection bag when the fan is not operating and to be opened by the force of air from the fan when it is operating.

U.S. Pat. No. 4,788,789 discloses a collapsible insect trap containing a light source, a fan, and a collection jar. The device is constructed so that its body and legs can telescope, thereby permitting it to be significantly reduced in size from its operational configuration for transport or storage.

U.S. Pat. No. 5,157,865 discloses a mosquito catcher having a fluorescent lamp installed on a cantilever secured above a fan, a mosquito-attracting agent placed on the catcher for luring the mosquito flying to the lamp so as to suck the mosquitoes by the fan impeller into a cone-shaped net secured under the fan impeller for killing the mosquitoes, which spirally impact against the net and are then killed and collected in a collector secured on a lower portion of the net.

U.S. Pat. No. 5,323,556 discloses a trap including an enclosure from which it is possible to draw air; an opening in the enclosure which enables outside air to be drawn therein as a result of the reduced pressure, and through which mosquitoes or night flying insects can be sucked inside the enclosure; and a container which is associated with the enclosure that is separate from the device that draws air therefrom receives mosquitoes or night flying insects which have been sucked into the enclosure.

U.S. Pat. No. 5,329,725 discloses an air transmissible bag member mounted coaxially relative to a bug light assembly at a lowermost end thereof to receive bug members dispelled from the bug light assembly and directed into the bag by way of interposed fan assembly between the bug light assembly and the bag.

U.S. Pat. No. 6,286,249 discloses a device for attracting and capturing or otherwise disabling insects using a fan mechanism structured and arranged to provide an outflow of air out of the device to atmosphere, and to draw an inflow directed counter the outflow from atmosphere into the device, the outflow being substantially within the inflow outside of the device. The flow mechanism is also structured and arranged to provide an insect attractant in the outflow. The device can include mounting structure being adapted to position the device with the outflow directed in a substantially downward direction. The outflow attracts insects to the vicinity of the device, and the inflow urges the insects to enter the device. An insect disabling structure is arranged with the flow mechanism to capture or otherwise disable insects being urged into the device by the inflow.

U.S. Pat. No. 6,655,080 discloses an insect trap barrel assembly spaced from a gas source where the assembly includes a cylindrically configured housing having an outer wall surface. An air intake wall is spaced from the outer wall surface and defines an annular configured air inflow channel. A fan assembly is mounted within the housing and communicates with the air inflow channel and draws outside air into the housing and traps insects that are drawn into the housing with the inflow of air. The air intake wall is dimensioned and spaced from the outer wall such that the inflow of air into the inflow channel creates a substantially laminar flow of air along the outer wall surface of the housing.

U.S. Pat. No. 6,840,003 discloses a light emitting insect trap comprising an insect attracting mechanism, a support framework, a suction producing mechanism, at least one section of netting, a releasable fastening device, a plurality of fan guards and a mounting means. The insect attracting mechanism is preferably a plurality of light emitting devices.

U.S. Pat. No. 7,036,269 discloses a multipurpose mosquito trap lamp base includes a base that admits light, a holder frame mounted in the base and holds an induced-draft fan at the front side and an ultraviolet lamp at the rear side, a hollow shell coupled to the rear side of the base for trapping mosquitoes, a filter cap capped on the rear side of the hollow shell for removing dust from air passing through the hollow shell, and an ozone generator mounted inside the base for generating ozone to sterilize air passing through the base and the hollow shell and the filter cap.

U.S. patent application publication no. 20090025275 discloses a process and device to attract a multitude of terrestrial and aerial arthropods using a plurality of light wavelengths emitted from light emitting diodes (LEDs). The selected light wavelengths increase trap capture rates by taking advantage of the insect's physiological and behavior instincts associated with vision and sensory perception. The LED wavelengths (light color) are selected to mimic the electromagnetic spectra of natural features, such as sugar and blood meal resources within the target insect's environment. Lighting platforms containing a plurality of LEDs produce the mimicking colors and can be optimally arranged in either a cylindrical fashion or on polygonal lighting chips.

U.S. patent application publication no. 20100212211 discloses a device for catching insects, comprising an attracting plane for attracting the insects to be caught, an opening which is arranged in the attracting plane and through which the insects can enter the device, wherein the opening is adjoined by a duct which extends into the interior of the device and comprising a ventilation device which generates an air flow passing through the duct.

U.S. patent application publication no. 20130064679 discloses a mosquito trap having a board and has a center, a funnel-shaped shell, multiple air holes and a through hole. The shell is formed downward in the center and is tapered off to a bottom. The air holes are respectively formed through the shell and are arranged radially and spirally. The through hole is formed on the bottom of the shell. The radial and spiral air holes are designed according to direction of airflow created by a fan so allow the airflow to pass smoothly therethrough and to generate steady suction forces.

Thus, the known devices, systems, and method for collecting mosquitoes and other biting insects for study provide operational challenges for field deployment such as acquiring a source of carbon dioxide or power. Moreover, known human-baited insect trapping systems or methods are being banned due to safety and ethical concerns even though it is well known that human odor, created from expelled carbon dioxide, heat, and/or perspiration, is the best way to attract mosquitoes and other biting insects. There is a need, therefore, for a safe, effective, human-baited trap for the collection of insects suitable for scientific study.

### SUMMARY

The device of the present invention, therefore, is an insect trap for collecting flying insects, said trap comprising: a housing; a means within the housing for forcing air movement, said means for forcing air movement having an air intake side fluidically connected to an open-air intake channel and an air expelling side fluidically connected to an air expelling channel; a means for containing an attractant, said means for containing the attractant fluidically connected to the air expelling channel of said means for forcing air movement, said means for containing the attractant further fluidically connected to an open-air exhaust channel within said housing, said means for containing an attractant further comprising a fluid path for air flow from said means for forcing air movement through said means for containing an attractant, around said attractant, and out of said open-air exhaust channel; a means for collecting insects, said means for collecting insects disposed between said means for forcing air movement and said open-air intake channel, said means for collecting insects having a first side, said first side fluidically connected to open-air and a second side, said second side fluidically connected to said air intake side of said means for forcing air movement, said second side of said means for collecting insects further comprising means for preventing insects from exiting said means for collecting insects.

In another embodiment, the present invention comprises a method of trapping flying insects, said method comprising the steps of: providing a selectively closeable housing, said housing having a means within the housing for forcing air movement, said means for forcing air movement having an air intake side fluidically connected to an open-air intake channel and an air expelling side fluidically connected to an air expelling channel, said means for forcing air movement operably attachable to a power source; providing a means for containing said attractant, said means for containing the attractant fluidically connected to the air expelling channel of said means for forcing air movement, said means for containing the attractant further fluidically connected to an open-air exhaust channel within said housing, said means for containing an attractant further comprising a fluid path for air flow from said means for forcing air movement, through said means for containing an attractant, around said attractant, and out of said open-air exhaust channel; providing a means for collecting insects, said means for collecting insects disposed between said means for forcing air movement and said open-air intake channel, said means for collecting insects having a first side, said first side fluidically connected to open-air and a second side, said second side fluidically connected to said air intake side of said means for forcing air movement, said second side of said means for collecting insects further comprising means for preventing insects from exiting said means for collecting insects.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

In the drawings:

FIG. 1 shows a side view of an exemplary embodiment of an insect trap system according to the present invention.

FIG. 2 shows a side view of an alternative exemplary embodiment of an insect trap system according to the present invention.

FIG. 3 shows a top view of an exemplary embodiment of an insect trap system according to the present invention.

FIG. 4 shows a top view of an alternative exemplary embodiment of an insect trap system according to the present invention.

FIG. 5 shows a front view of an open housing according to an exemplary embodiment of an insect trap system according to the present invention.

FIG. 6 shows a close up front view of selected components within the housing shown in FIG. 5.

FIG. 7 shows a top view of an open housing according to an exemplary embodiment of an insect trap system according to the present invention.

FIG. 8 shows a close up top view of selected components within the housing shown in FIG. 7.

FIG. 9 shows an exemplary embodiment of an insect specimen container according to an exemplary embodiment of the present invention.

FIG. 10 shows the container of FIG. 9 with a diagram of the air flow within the container.

FIG. 11 shows a side cross sectional view of an alternative embodiment of the components in FIG. 6, with directed air flow.

FIG. 12 shows a side cross sectional view of an alternative embodiment of the components in FIG. 6, with the directed air flow.

FIG. 13 shows a top view of a baffle for creating a pulsed air flow.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

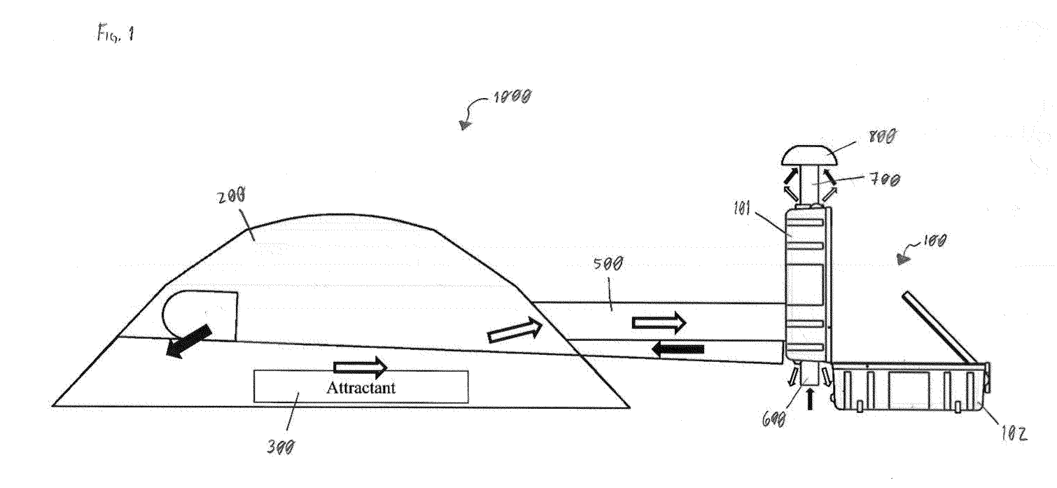

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring first to FIG. 1, there is shown a side view of an exemplary embodiment of an insect trap system 1000 according to the present invention. As shown in FIG. 1, insect trap system 1000 generally comprises selectively closable housing 100 and attractant container 200.

Housing 100 comprises top portion 101 and bottom portion 102. In the embodiment shown in FIG. 1, top portion 101 of housing 100 and bottom portion 102 of housing 100 are hingedly connected to one another.

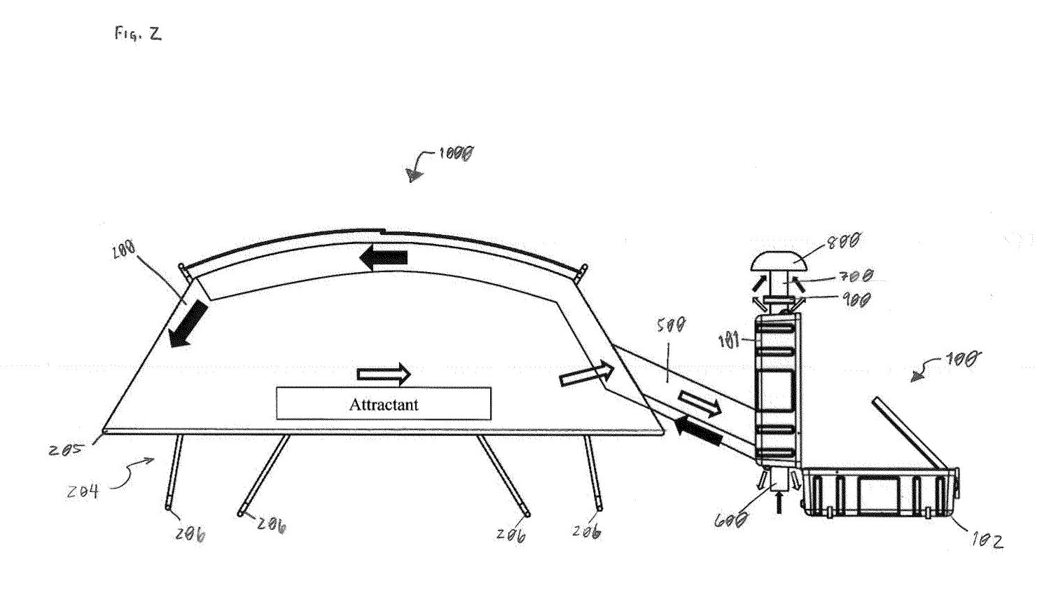

Referring still to FIG. 1, housing 100 further comprises at least one open-air inlet. In the exemplary embodiment illustrated in FIG. 1, housing 100 comprises top open-air inlet 700 and bottom open-air inlet 600. As shown in FIG. 1, open air inlets 600 and 700 are generally on opposing sides of top portion 101 of housing 100. As further shown in FIG. 1, insect trap system 1000 may further comprise a light source 900 (shown in FIG. 2) and dome 800 disposed atop open-air inlet 700. Dome 800 may be used to both protect against external weather conditions and to manipulate air flow.

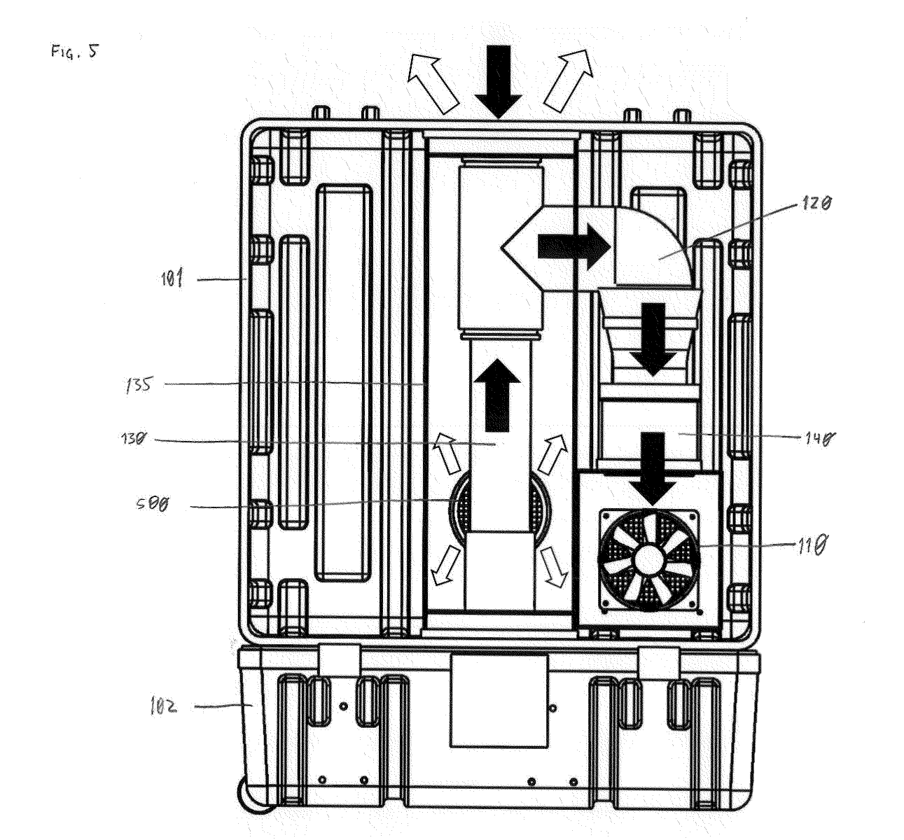

Housing 100 further comprises a means to move air in a desired direction. Preferably, such means comprises fan assembly 110 (shown in FIG. 5). As further illustrated in FIG. 1, housing 100 (specifically fan assembly 110, not shown) is fluidically connected to attractant container 200 via ducts 400 and 500. Ducts 400 and 500 are preferably comprised of a plastic, fabric, or other light weight corrosion resistant material.

Insect trap system 1000 further comprises a power source (not shown) operably connected to fan assembly 110. The power source is preferably a lightweight high performance lead-acid or lithium ion battery. The housing preferably further includes a compactable solar array for recharging the power source or directly powering insect trap system 1000. The power source should have at least 12 hours operating time per charge cycle under standard operating conditions.

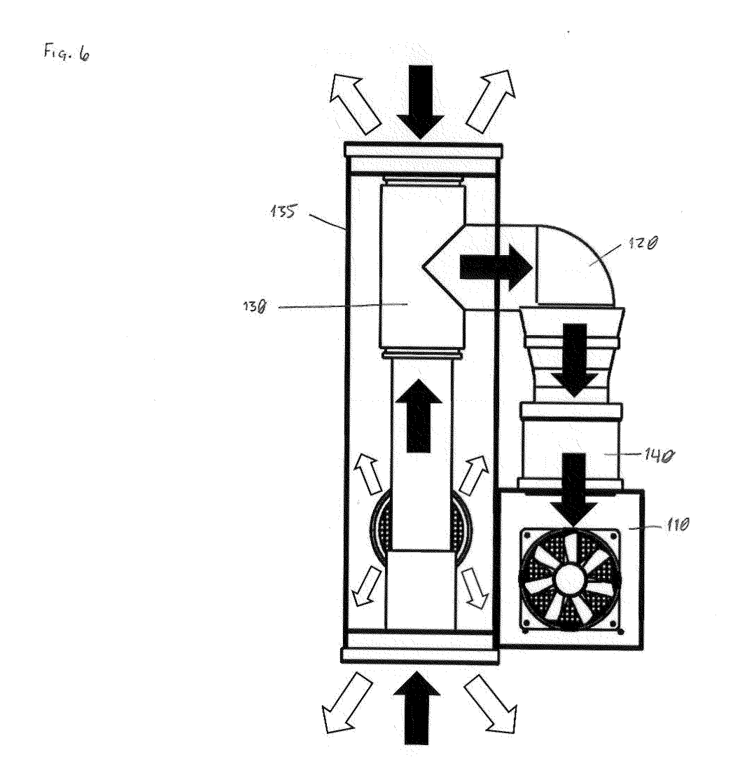

Referring still to FIG. 1, fan assembly 110 (shown in FIG. 5) comprises an air expelling side and an air intake side. The air expelling side of fan assembly 110 is fluidically connected to duct 400, and the air intake side of fan assembly 110 is fluidically connected to open air intakes 610 and 710. Exhaust duct 500 is fluidically connected to housing 100, as shown and discussed herein below with reference to FIG. 5 and FIG. 6.

Again referring to FIG. 1, insect trap system 1000 further comprises attractant container 200. Attractant container 200 is fluidically connected to ducts 400 and 500. In some embodiments, attractant container 200 further comprises a screen, box, or other means for segregating the attractant.

Attractant container 200 preferably comprises a portable one or two person tent, but it may comprise any desired structure of appropriate size whether temporary or permanent. Attractant container 200 should comprise material that is free of any chemical repellent effects, and it should be chosen to minimize air leakage that would reduce the effectiveness of insect trap system 1000. Attractant container 200 may incorporate a lightweight supporting frame. Insect trap system 1000 should also be portable. Ideally housing 100 will weigh no more than 60 lb (27 kg), including a carry case and power supply.

Ideally, the attractant within attractant container 200 is a human. However, the attractant may be another mammal, a plant, an artificial or natural source of carbon dioxide, a light, or a combination of the same.

As illustrated in FIG. 1, air flows from housing 100 (specifically, fan assembly 110, not shown) out through duct 400 (black arrows) into attractant container 200. Air then flows around the attractant and out (white arrows) of attractant container 200 through exhaust duct 500 to housing 100.

Referring next to FIG. 2, there is shown a side view of an alternate embodiment of insect trap system 1000 according to the present invention. As illustrated in FIG. 2, insect trap system 1000 further comprises a stand 205. Stand 205 comprises at least four legs 206 supporting attractant container 200. Stand 204 may further comprise a platform (205) to which legs 206 are attached.

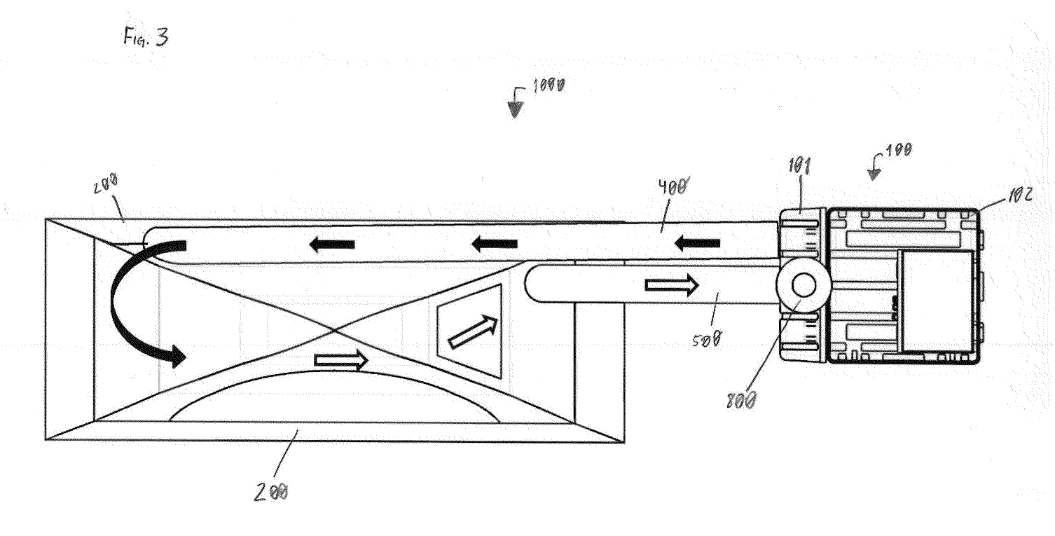

Turning now to FIG. 3, there is shown a top view of an exemplary embodiment of insect trap system 1000 according to the present invention. As illustrated in FIG. 3, insect trap system 1000 generally comprises selectively closable housing 100 and attractant container 200.

As illustrated in FIG. 3, closable housing 100 comprises top 101 and bottom 102. Top 101 and bottom 102 are hingedly connected to one another. Housing 100 further comprises a means to move air in a desired direction. Preferably, such means comprises fan assembly 110 (shown in FIG. 5).

Again referring to FIG. 3, insect trap system 1000 further comprises attractant container 200. Attractant container 200 is fluidically connected to ducts 400 and 500. In some embodiments, attractant container 200 further comprises a screen, box, or other means for segregating the attractant. As further illustrated in FIG. 3, housing 100 (specifically fan assembly 110, not shown) is fluidically connected to attractant container 200 via ducts 500 and 400.

Referring still to FIG. 3, fan assembly 110 (shown in FIG. 5) comprises an air expelling side and an air intake side. The air expelling side of fan assembly 110 is fluidically connected to duct 400, and the air intake side of fan assembly 110 is fluidically connected to air intake ducts 120 and 130 (shown in FIGS. 5 and 6).

As illustrated in FIG. 3, air flows from housing 100 (specifically, fan assembly 110, not shown) out through duct 400 (black arrows) into attractant container 200. Air then flows around the attractant and out (white arrows) of attractant container 200 through exhaust duct 500 to housing 100. The air exiting insect trap system 1000 contains the scent of the attractant inside the tent. This scent is then “broadcast” with the exhaust air to attract insects.

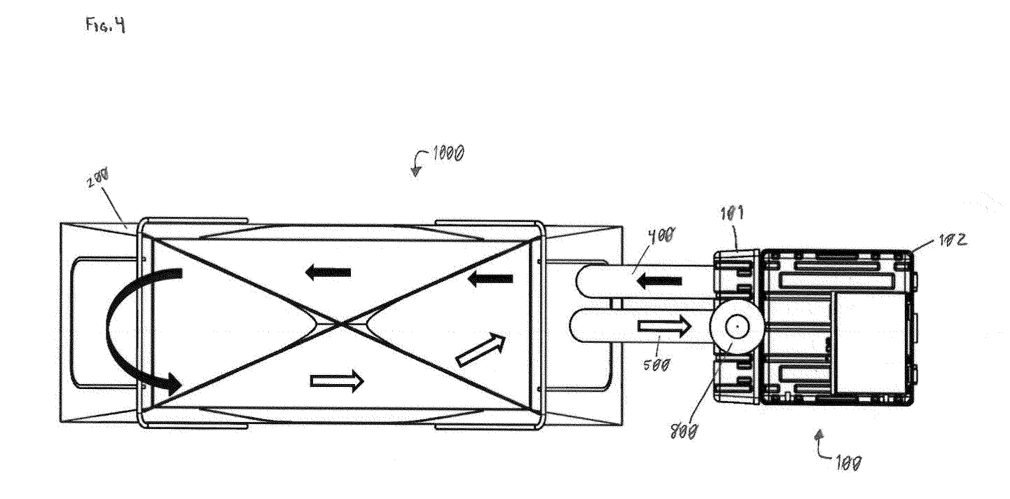

Referring now to FIG. 4, there is shown a top schematic view of an alternative exemplary embodiment of insect trap system 1000 according to the present invention. As illustrated in FIG. 4, the duct 400 is fluidically connected to attractant container 200 at a point closer to housing 100 than in the embodiment of insect trap system 1000 shown in FIG. 3.

Referring now to FIGS. 5 and 6, in FIG. 5, there is shown a front view of housing 100 while open according to an exemplary embodiment of insect trap system 1000 according to the present invention. In FIG. 6, there is shown a close up front view of selected components within housing 100 shown in FIG. 5.

As described previously herein, housing 100 of insect trap system 1000 comprises top 101 and bottom 102 hingedly connected to one another. Housing 100 further comprises fan assembly 110. Fan assembly 110 comprises an air expelling side that is fluidically connected to duct 400 as shown, for example, in FIG. 1. Fan assembly 110 further comprises a fresh air intake side fluidically connected to insect collection container 140. Insect collection container 140 is fluidically connected to air curved intake duct 120 which intersects vertically disposed air intake duct 130. The opposing ends of air intake duct 130 are connected to open air intakes 600 and 700. Those of skill in the art will appreciate that air intakes 600 and 700 open directly to open-air.

Referring still to FIGS. 5 and 6, housing 100 further comprises exhaust duct 135 disposed around air intake duct 130. Air exhaust duct 135 may empty directly to open air. However, air exhaust duct opens into exhaust ducts 600 and 700 (FIGS. 1 and 2). Those of skill in the art will appreciate that ducts 600, 610, 700, and 710 comprise a preferred embodiment of the invention, but they are not necessary for the basic function of the invention as ducts 130 and 135 may open directly to open air.

Referring again to FIGS. 5 and 6, exhaust duct 500 is fluidically connected to exhaust duct 135. FIG. 5 further shows the air flow within the system where the white arrows show air that has passed over the attractant, and the black arrows show intake air as well as the path of trapped insects. After being attracted to insect trap system 1000, insects are suctioned into intakes 600 and 700 and through the air intake system through ducts 130 and 120 and then into insect collection container 140.

Insect collection chamber 140 is fluidically connected on one side to air intake duct 120 and on another side to fan assembly 110. A screen or other means is disposed within collection container 140 to prevent any insects from exiting collection container 140 into fan assembly 110. Fan assembly 110 is a commercially available fan assembly that runs on DC power. Preferably, fan assembly 110 has a 120 Cubic Feet per Minute (“CFM”) air flow capacity. As previously discussed, the specimen is attracted by the attractant and pulled into air intake 600 and 700, which are situated to allow insects to enter insect trap system 1000 from 360 degrees. As air exiting the tent is the chief attractant, the air inlets 600 and 700 are placed in close proximity to the air outlets 610 and 710 to maximize the insect catch while also allowing some of the attractant to be recirculated through the trap.

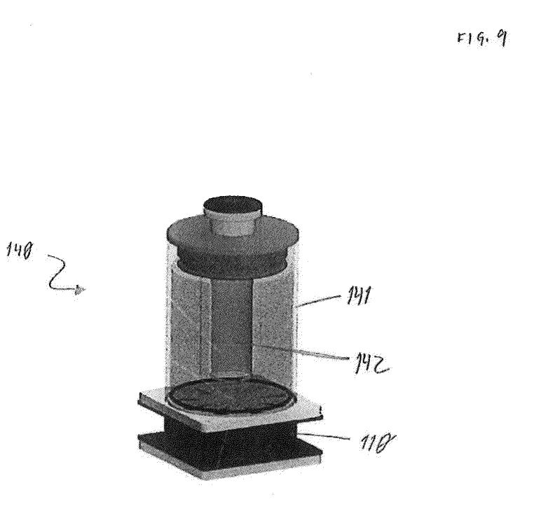

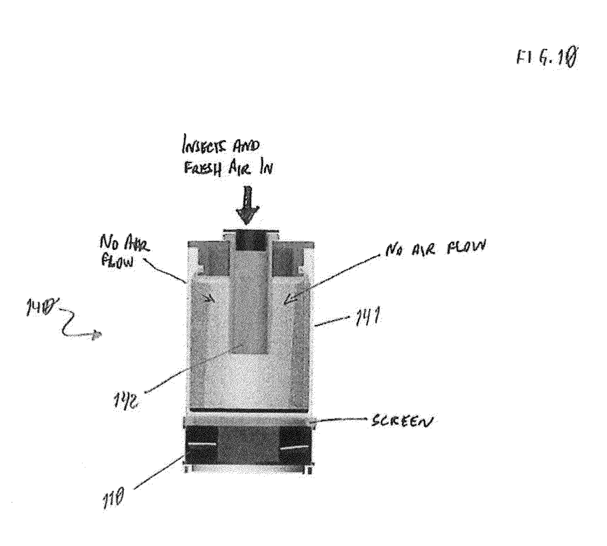

Turning briefly to FIGS. 9 and 10, there is shown a detailed view of an exemplary embodiment to insect collection container 140. Collection container 140 comprises casing 141 and inner access tube 142. Access tube 142 ends short of the bottom of the container 140. When insect specimens exit tube 142 and enter the larger diameter of collection container 140, there is a dramatic and immediate reduction in the velocity of the air passing by the specimen. This reduction is important because it will prevent the live specimen from being damaged or dried out before it is recovered. In addition to this feature to lower the amount of airflow past the specimen, the proposed collection jar configuration provides a zero airflow zone at any location within the collection jar that is above the end of the access tube 142. Insects naturally seek those areas of refuge without air flow. This will preserve the live specimens in suitable (i.e. at least 90% of specimens should be able to be morphologically identified as a particular species), condition for evaluation.

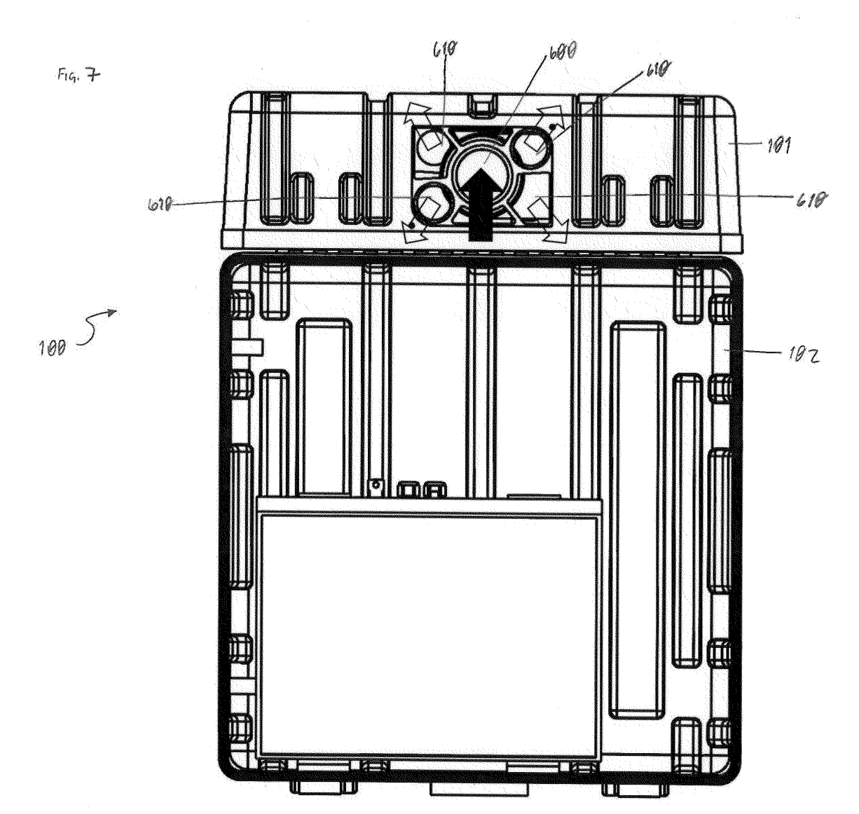

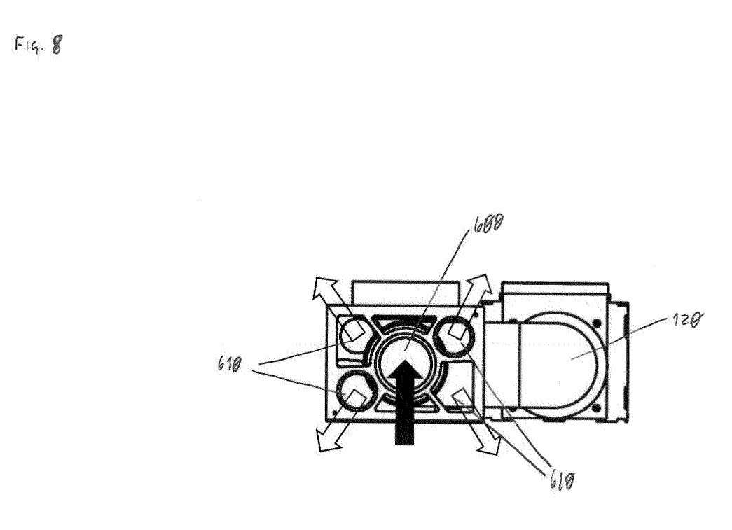

Referring now to FIGS. 7 and 8, in FIG. 7, there is shown a top view of an open housing 100 according to an exemplary embodiment of an insect trap system according to the present invention. In FIG. 8, there is shown a close up top view of selected components within housing 100 shown in FIG. 7. Specifically those figures show the exhaust air (exhaust outlets 610 and 710) coaxial to the intake air (intake inlets 600 and 700).

Advantageously, insects collected with the present system 1000 never pass through fan blades. This prevents trauma to the specimens that could otherwise result from its impact with the fan blades.

FIGS. 7 and 8 illustrate the flow of air into (black arrows) and out of (white arrows) of insect collection system 1000. As further illustrated in FIGS. 7 and 8, exhaust duct 135 may comprise multiple ports around open air intakes 600 and 700. Those of skill in the art will no doubt appreciate that the present system might easily be adapted to use accessory attachments to manipulate the air flow or allow inlet and outlet to open directly to open air.

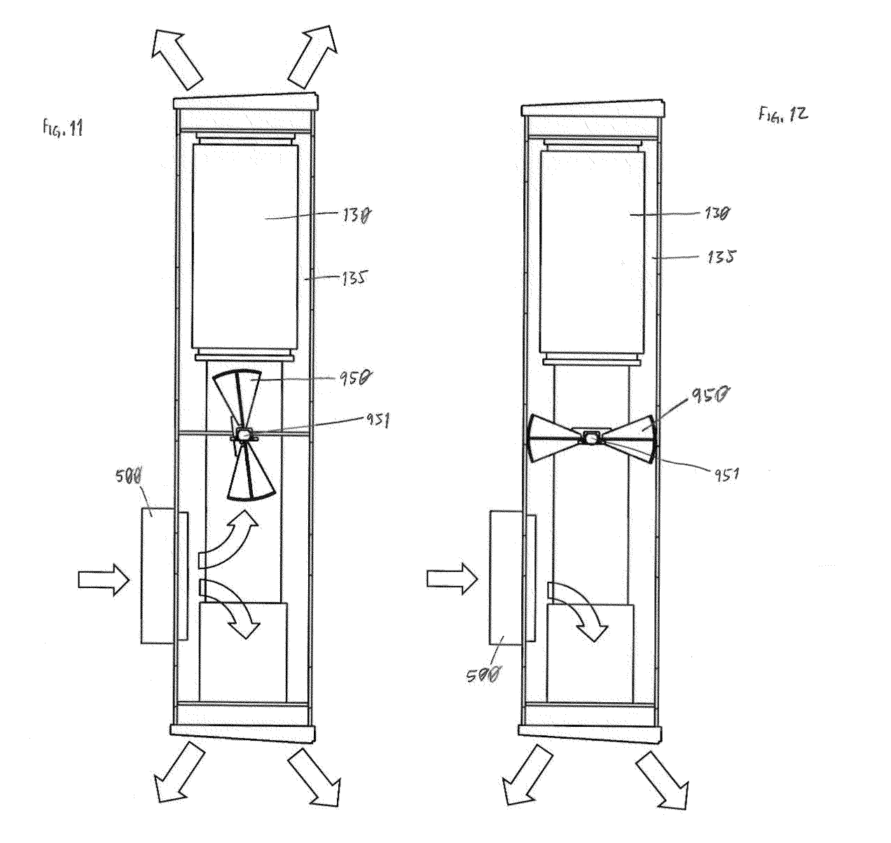

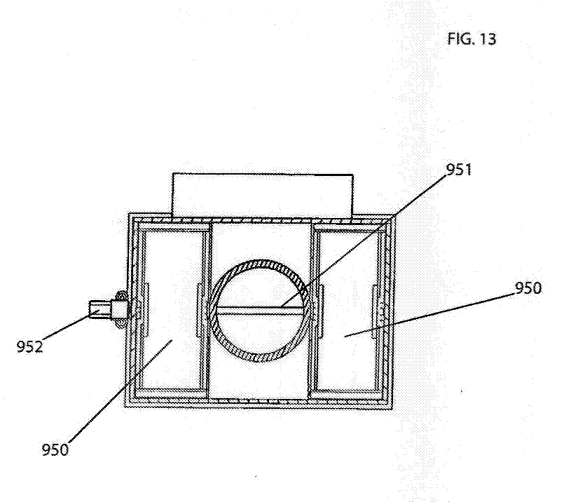

Turing now to FIG. 11, there is shown a side cross sectional view of exhaust duct 135. Again, FIG. 11 further shows the air flow within the system where the white arrows show air that has passed over the attractant.

As illustrated in FIG. 11, exhaust duct 135 of insect collection system 1000 further comprises a means for selectively directing the flow of infused air through exhaust duct 135. In an exemplary embodiment, said means for selectively directing the flow of infused air (air that has passed over the attractant) comprises a motorized rotating baffle 950. The shaft 951 supporting baffle 950 is driven at a low speed, preferably about 7 rpm, by an attached electric motor 952 (shown in FIG. 13). Baffle 950 periodically blocks the flow of infused air through exhaust duct 135. Preferably, the air flow is blocked in one direction at a time only to provide a pulsed air flow in both exhaust directions, thereby simulating the pulse of a human or animal breathing pattern.

Those of skill in the art will appreciate that rotating baffle 950 is just one possible means of effecting pulsed air flow through exhaust 135. Other means might include a closable vent, a slide, or simply pulsing the operation of the fan.

Another key advantage of the present invention is that the total CFM capacity of airflow through the entire trap system 1000 is unlimited and can be easily increased by an order of magnitude if desired.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A trap system for collecting flying insects, said trap comprising:
a selectively closeable housing;
a means within the housing for forcing air movement, said means for forcing air movement having an air intake side fluidically connected to an open-air intake channel and an air expelling side fluidically connected to an air expelling channel, said means for forcing air movement operably attachable to a power source;
a means for containing an attractant, said means for containing the attractant fluidically connected to the air expelling channel of said means for forcing air movement, said means for containing the attractant further fluidically connected to an open-air exhaust channel within said housing, said means for containing an attractant further comprising a fluid path for air flow from said means for forcing air movement through said means for containing an attractant, around said attractant, and out of said open-air exhaust channel;
a means for collecting insects, said means for collecting insects disposed between said means for forcing air movement and said open-air intake channel, said means for collecting insects having a first side, said first side fluidically connected to open-air and a second side, said second side fluidically connected to said air intake side of said means for forcing air movement, said second side of said means for collecting insects further comprising means for preventing insects from exiting said means for collecting insects.

2. The insect trap of claim 1, wherein the attractant is an animal, said animal selected from the group consisting humans, pigs, cows, chickens, rabbits and dogs.

3. The insect trap of claim 1, wherein the attractant is a plant.

4. The insect trap of claim 1, wherein the housing comprises a material selected from the group consisting of a plastic, a metal, and a composite.

5. The insect trap of claim 1, wherein the means within the housing for forcing air movement comprises a fan assembly.

6. The insect trap of claim 1, wherein the means for containing an attractant comprises a tent.

7. The insect trap of claim 1, wherein the means for collecting insects comprise a clear container comprising a casing made of a material selected from a group consisting of glass and clear plastic.

8. The insect trap of claim 7, wherein the means for preventing insects from exiting the trap through the container comprises a screen.

9. The insect trap of claim 1, wherein the power source is located within the housing.

10. The insect trap of claim 9, wherein said internal power source is selected from the group consisting of a lead acid battery, a nickel cadmium battery, a lithium ion battery, and a solar cell.

11. The insect trap of claim 1, wherein the power source is located outside the housing.

12. The insect trap of claim 11, wherein said external power source is selected from the group consisting of a lead acid battery, a nickel cadmium battery, a lithium ion battery, and a solar cell.

13. The insect trap of claim 1, wherein said means for moving air moves air in a desired direction at a flow rate of at least about 120 ft³/minute.

14. The insect trap of claim 1, wherein said means for moving air moves air in a desired direction at a flow rate of no more than about 120 ft³/minute.

15. The insect trap of claim 1, further comprising a light source disposed near said open-air intake channel.

16. The insect trap of claim 15, wherein said light source is selected from the group consisting of LED, UV, incandescent, and infrared.

17. The insect trap of claim 1, wherein said air inlet channel and said air exhaust channel are coaxial.

18. The insect trap of claim 1, wherein said air inlet and said air exhaust channels allow for air flow within a radius of 360 degrees about the longitudinal axis of said channels.

19. The insect trap of claim 1, wherein said collection container includes an area having an air flow rate of less than about 5 ft³/min.

20. The insect trap of claim 1, wherein said collection container includes an area having an air flow rate of less than about 1 ft³/min.

21. A method of trapping flying insects, said method comprising the steps of:
Providing a selectively closeable housing, said housing having a means within the housing for forcing air movement, said means for forcing air movement having an air intake side fluidically connected to an open-air intake channel and an air expelling side fluidically connected to an air expelling channel, said means for forcing air movement operably attachable to a power source;
Providing a means for containing said attractant, said means for containing the attractant fluidically connected to the air expelling channel of said means for forcing air movement, said means for containing the attractant further fluidically connected to an open-air exhaust channel within said housing, said means for containing an attractant further comprising a fluid path for air flow from said means for forcing air movement through said means for containing an attractant, around said attractant, and out of said open-air exhaust channel;
Providing a means for collecting insects, said means for collecting insects disposed between said means for forcing air movement and said open-air intake channel, said means for collecting insects having a first side, said first side fluidically connected to open-air and a second side, said second side fluidically connected to said air intake side of said means for forcing air movement, said second side of said means for collecting insects further comprising means for preventing insects from exiting said means for collecting insects.

22. The method of claim 21, wherein the attractant is an animal, said animal selected from the group consisting of humans, pigs, cows, chickens, rabbits and dogs.

23. The method of claim 21, wherein the attractant is a plant.

24. The method of claim 21, wherein the housing comprises a material from the plastic group consisting of a plastic, a metal, and a composite.

25. The method of claim 21, wherein the means within the housing for forcing air movement comprises a fan assembly.

26. The method of claim 21, wherein the means for containing an attractant comprise a tent.

27. The method of claim 21, wherein the means for collecting insects comprises a clear container comprising a material selected from the group consisting of glass and plastic.

28. The method of claim 27, wherein the means for preventing insects from exiting the insect collection means consists of a screen.

29. The method of claim 21, wherein the power source is located within the housing.

30. The method of claim 29, wherein said internal power source is selected from the group consisting of a lead acid battery, a nickel cadmium battery, a lithium ion battery, and a solar cell.

31. The method of claim 21, wherein the power source is located outside the housing.

32. The method of claim 27, wherein said external power source is selected from the group consisting of a lead acid battery, a nickel cadmium battery, a lithium ion battery, and a solar cell.

33. The method of claim 21, wherein said means for moving air moves air in a desired direction at a flow rate of at least about 120 ft³/minute.

34. The method of claim 21, wherein said means for moving air moves air in a desired direction at a flow rate of no more than about 120 ft³/minute.

35. The method of claim 21, further comprising a light source disposed near said open-air intake channel.

36. The method of claim 35, wherein said light source is selected from the group consisting of LED, UV, incandescent, and infrared.

37. The insect trap of claim 1, wherein air is expelled from the trap in intermittent pulses.

38. The insect trap of claim 1, wherein air is expelled from the trap in intermittent pulses generally consistent with a pattern of human breathing.

39. The method of claim 21, further comprising the step of providing a means for selectively preventing air flow from departing the trap.

40. The method of claim 21, further comprising the step of providing a means for selectively preventing air flow from departing the trap in intermittent pulses generally consistent with a pattern of human breathing.
